(19) United States
(12) Patent Application Publication
(10) Pub. No.: US 2012/0270942 A1
(43) Pub. Date: Oct. 25, 2012

(54) Spreading Active Agricultural Agents

(75) Inventors: Andreas Greiner, Amoeneburg (DE); Joachim H. Wendorff, Nauheim (DE); Seema Agarwall, Marburg (DE); Christoph Hellmann, London (GB); Michael Breuer, Sasbach (DE); Günter Leithold, Langgoens (DE); Hans E. Hummel, Giessen (DE); Detlef Hein, Blankenheim (DE)

(73) Assignees: Justus-Liebig-Universitat Giessen, Giessen (DE); Baden-Wurttemberg Versuchs- und Forschungsanstalt fur Weinbau und Weinbehandlung, Freiburg Im Breisgau (DE); Staatliches Weinbauinstitut der Landwirtschaftsverwaltung; Philipps-Universitat Marburg, Marburg (DE)

(21) Appl. No.: 13/503,277

(22) PCT Filed: Oct. 21, 2010
(86) PCT No.: PCT/EP2010/065913

§ 371 Date: Jul. 12, 2012

(30) Foreign Application Priority Data
Oct. 21, 2009 (EP) 09173695.9

(51) Int. Cl. A01N 37/02; B29C 47/10; A01P 17/00

(52) U.S. Cl. 514/546; 264/465

(57) ABSTRACT

Disclosed herein is a device for the application of agricultural active agents, wherein the device is suitable to be brought to the site of action in a manner temporally and spatially separated from the production process, and comprises a dispenser and non-water-soluble nanofibers and/or mesofibers charged with agricultural active agents. The polymers from which the nanofibers and/or mesofibers are made are preferably biodegradable. The agricultural active agents are selected from fungicides, herbicides, batericides, plant growth regulators and plant nutrients. These are preferably pheromones, kairomones and signaling substances. Furthermore, a method for the production of this device is disclosed, wherein the nanofibers and/or mesofibers charged with active agents are produced via electrospinning. The device is suitable to be used to bring agricultural active agents to the site of action in a manner temporally and spatially separated from the production of this device. The application is suitable to be carried out mechanically or automatically. This is preferably agricultural land used for fruit growing, viticulture, gardening or a commercial row crop. The device according to the present invention is particularly suitable to be used for the regulation of arthropods.

### BACKGROUND OF THE INVENTION

1. Field of the Invention

The present invention relates to the fields of agricultural sciences, biotechnology, material sciences and nanotechnology.

2. Brief Description of Related Technology

In the following, ‘agricultural active agents’ are understood to be known active agents which occur in nature or are extracted through the use of chemical methods or are produced through the use of chemical and/or microbiological methods for plant and/or ground treatment, such as: fungicides, batericides, insecticides, acaricides, nematicides, helminthicides, herbicides, molluscicides, rodenticides, algaecides, aphicides, larvicides, ovicides, food attractants, antifeedants, kairomones, pheromones and other signaling substances for the management of arthropods, repellents, game repellents. Systemic means are plant growth regulators or plant nutrients, including but not limited to fertilizers.

In particular, substances for influencing animals around the plants are understood by the term insecticides. In addition to chemically or microbiologically produced agents, these agents are suitable to be naturally occurring active agents, such as extracts from the neem tree or the quassia root, and other such substances which influence, inter alia, the sexual behavior and the egg-laying behavior of the animals around the plants, e.g. pheromones.

A whole array of methods for application of active substances is known. Using these methods, these active agents are suitable to be used to nourish the ground or plants.

These methods are the application of
1) liquids in droplet form by aerial spraying, spraying, nebulizing, brushing and drip irrigation;
2) solids in the form of granules and powders, and
3) gaseous active substances via different dispensers.

Examples for 1 are the methods which have long been the conventional methods for application or distribution, i.e. by means of watering cans, hand sprayers, backpack sprayers, tractors, helicopters and aircraft.

In addition to granules and powders, examples for 2 also are absorbates on fixed natural or artificial particles, e.g. corn cob pellets, on which the kairomone MCA was absorbed. By way of example, this is described in Hummel H. E., Metcalf, R. L. (1996). Diabrotica barberi and D. virgifera virgifera fail to Orient Towards Sticky Traps in Maize Fields Permeated with the Plant Kairomones p-methoxy-phenylethanol and p-methoxy-trans-cinnamaldehyde. Med. Fac. Landbouww. Univ. Gent 61/3b, 1011-1018; Hummel, H. E., Hein, D. F., Metcalf, R. L. (1997). Orientation disruption of Western Corn Rootworm Beetles by Air Permeation with Host Plant Kairomone Mimics. p. 36 in: 2nd FAO WCR/TCP Meeting and 4th International IWGO Workshop, Oct. 28-30, 1997, Godollo, Hungary, J. Kiss, ed. and Wennemann, L., H. E. Hummel. 2001. Diabrotica beetle orientation disruption with the plant kairomone mimic 4-methoxycinnamaldehyde in Zea mays L. Mitt. Dtsch. Ges. allg. angew. Ent. 13: 209-214. Extensive developmental work has been poured into the dispenser technology. A critical overview of the state of the art reached for the technology by 1982 may be found in the monograph by Leonhardt, B. A., Beroza, M. (eds.) (1982). Insect pheromone technology: chemistry and applications. ACS Symposium Series #190. American Chemical Society, Washington D.C. ISBN 0-8412-0724-0. Further examples may be found in Hummel, H. E., Miller, T. A., eds (1984). Techniques in Pheromone Research. Springer, New York. ISBN 0-387-90919-2. In F Trona, G Anfora, M Baldessari, V Mazzoni, E Casagrande, C Ioratti, G Angeli: “Mating disruption of codling moth with a continuous adhesive tape carrying high densities of pheromone dispensers”, Bull Insectol 2009, 62, 7-13, a continuous adhesive tape with dispensers is described, which comprise (E,E)-8,10-dodecadien-1-ol (Codlemone®) and is suitable to be automatically applied, for example with a modified leaf tying machine. In the following papers, methods for combating the corn rootworm Diabrotica virgifera virgifera are described:
1. H E Hummel, J T Shaw, D F Hein: A promising biotechnical approach to pest management of the western corn rootworm in Illinois maize fields shielded with a MCA kairomone baited trap line. Mitt. dtsch. Ges. allg. angew. Ent. 2006, 15, 131-135
2. H E Hummel, A Deuker, G Leithold: The leaf beetle Diabrotica virgifera virgifera LeConte: a merciless entomological challenge for agriculture. IOBC/wprs Bulletin 2009, 41, 103-110.
3. H E Hummel: Diabrotica virgifera virgifera LeConte: inconspicuous leaf beetle—formidable challenges to agriculture. Comm. Appl. Biol. Sci. 2007, 71, 7-32.
4. H E Hummel, M Bertossa, A Deuker: The current status of Diabrotica virgifera virgifera in selected European countries and emerging options for its pest management. pp. 338-348. In: FELDMANN, F., ALFORD, D. V. & FURK, C. (eds.). Crop plant resistance to biotic and abiotic factors: current potential and future demands. Proceedings of the 3^{rd} International Symposium on Plant Protection and Plant Health in Europe, Berlin, Germany, 14-16 May 2009. DPG Selbstverlag.

The method provided for 2 is usually used for the application of fertilizers.

Examples provided for 3 are pheromones which are evaporated from half open PTFE capillaries, e.g. formulated with adhesive and distributed via aircraft. This is described in Brooks, T. W., Doane, C. C., Staten, R. T. (1979). Experience with the first commercial pheromone communication disruptive for suppression of an agricultural insect pest. pp 375-388. In: Chemical Ecology: Odour Communication in Animals, ed. F. J. Ritter. Amsterdam: Elservier/North Holland Biomedical. ISBN 0-444-80103-0. Double room dispensers by Hercon Laboratories Corp., York, Pa., USA for pheromones such as those used by BASF AG in fruit growing and viticulture should also be pointed out. Finally, the “Lecture-bottle” buffer systems described by Shorey, H. H., Gerber, R. G. 1996. Use of puffers for disruption of sex pheromone communication of codling moths (Lepidoptera: Tortricidae) in walnut orchards. Environ. Entomol 25 (6): 1398-1400, in which compressed signaling agent solutions are preserved and from which formulations are dispensed via valves by means of radio commands.

The disadvantage of these methods is that the delivery of the active agents is not continual, it only occurs over an extremely limited period of time, and disruptive factors such as wind and rain have a highly adverse effect on this method of delivery and the disposition of the agent across the target area (e.g. the ground in the area of plants to grow there later or ones which are already growing there, or the surfaces of plants). The consequence of this is that the active agent must be applied several times for the desired provision of active agents over a longer period of time, which is associated with increased costs. The alternative of a single application of the whole amount of the active agent runs the risk of the active agents being diverted to the non-target area, thereby causing a financial loss to the user at the least, if not an undesired ecological impact in non-target areas. Removal via water into the soil or into lakes, streams and rivers is a typical example.

In these cases, carrier materials or systems such as those described for medicinal active agents and for active agents for agriculture are advantageous. These include, by way of example, biodegradable polymerfibers charged with agricultural active agents or polymer shaped bodies. For the adjustment of the release, the surface to polymer fiber or polymer shaped body volume ratio is extremely important in all cases. This ratio is particularly favorable for nanostructured fibers and increases very sharply as fiber diameters decrease.

In principle, several suitable carriers of active agents and their production methods are already known as the results of nanotechnology research.

Electrospinning represents a particularly favorable method both for careful integration of the active agents in the carriers and for the control of the fiber diameters as far as into the nanometer scale.

Details regarding the electrospinning process are described, for example, in H. Reneker, I. Chun, Nanotechn. 7, 216 (1996) or Fong, H.; Reneker, D. H.; J. Polym. Sci, Part B 37 (1999), 3488 and in DE 100 23 45 69. An overview of electrospinning is also provided in A Greiner, J H Wendorff: “Electrospinning: A Fascinating Method for the Preparation of Ultrathin Fibers.” Angew Chem Int Ed 2007, 46, 5670-5703.

For electrospinning, the fibers are formed via a high electrical voltage set up between a nozzle and a counter electrode. The material to be spun is hereby provided in the form of a melt and/or a solution, and is transported through the nozzle. The electrical field leads to a deformation of the droplet, leaving the nozzle via induced charges; a fine material flow is formed which is accelerated in the direction of the counter electrode. The material flow hereby traverses several physical instabilities based on electrostatic repulsion, is attenuated, and is finally deposited on a substrate.

The fibers are deposited with a speed of several meters per second; the fibers themselves are suitable to be produced up to a length of several meters. The final result is a very fine fiber web on the substrate. Through adjustment of the concentration of the solution, the attached field and the temperature via the use of additives and other parameters such as additional electrodes, the viscosity, the processing temperature etc., the diameters of the fibers achieved are suitable to be adjusted in a wide range. Fibers as small as only several nanometers or larger variations are obtainable; large-scale fiber arrangements up to the square meter range are hereby suitable to be deposited on the substrate or the target area.

Fibers made from amorphous or semi-crystalline polymers, block-copolymers, polymer alloys are suitable to be produced in this way. For example, nanofibers were thus produced from such diverse natural and synthetic polymers, such as polyamides, polycarbonate or polymethylmethacrylate, from polynorbornenes, from polyvinylidene fluoride, from cellulose, from polylactides. The precise adjustment of the control parameters for the electrospinning is necessary for the respective material. Examples are the electrode material, the electrode form and electrode arrangement, the presence of auxiliary electrodes and gate electrodes, the viscosity of the melt or solution of the template material, respectively, and their surface tension and conductivity. If these parameters are not selected as effectively as possible, droplets are rather deposited than fibers, the diameter will be in the micrometer range, or the fiber diameters will fluctuate strongly. For the properties of the fibers, it is important that there is a partial orientation of the chain molecules in the fibers during the electrospinning, as was shown via electron diffraction on a fiber with a diameter of approximately 50 nm. The orientations obtained are of absolutely the same order of magnitude as melt-extruded commercial fibers. In the case of a suitable, targeted selection of spinning parameters, it is also possible to incorporate droplets in a targeted manner in fibers.

A major advantage of electrospinning is that water is also suitable to be used as a solvent, so that water-soluble polymers and water-soluble biological system are suitable to be spun. Examples are polyvinyl alcohol, polyvinylpyrrolidone, polyethylene oxide. Tissues and parallel strands are obtained depending on the arrangement and form of the electrodes. Examples from the results of the nanotechnology research in this regard are:

i) DE 100 23 456 A1, wherein hollow fibers with an inner diameter of 10 nm to 50 μm and an outer wall made from metal-containing inorganic compounds, polymers and/or metals are proposed which are suitable to be produced according to a first method in such a way that a fiber made from a first degradable material receives at least one coating made from at least one other material, and the first material is subsequently degraded with the aim that the hollow fiber obtained in this way comprises an inner diameter of 10 nm to 50 μm. As a second solution, a method is proposed in the specification stated above, wherein a fiber made from a first non-degradable material, is consecutively coated with a second degradable material and at least one further material, and the second degradable material is degraded with the aim that with regard to at least one further material a hollow fiber with an inner diameter of 10 nm to 50 μm and a core made from the first material is obtained. The subject matter of this specification was also provided for use in the field of “controlled release” in accordance with claim 21.
ii) DE 100 40 897 A1, wherein porous fibers made from polymeric materials are proposed, which comprise fibers with diameters of 20 to 4,000 nm and pores (for instance, for the absorption of active agents) in the form of channels extending at least to the fiber core and/or through the fiber. These fibers are produced according to claim 7 of the above specification in such a way that a 5 to 20 wt.-% solution of at least one polymer in a highly volatile organic solvent or solvent mixture is spun in a field of 1 to 100 kV via electrospinning, wherein the resulting fiber comprises diameter of 20 to 4,000 nm and pores in the form of channels extending at least to the fiber core and/or through the fiber. Surfaces of 100 to 700 m²/g are hereby achievable. In accordance with a preferred practical embodiment of the subject matter of this specification (column 4, paragraphs [0028] and [0029]), fibers which initially do not comprise any channels are also suitable to be produced by using two polymers (one water-insoluble and one water-soluble). These pores or channels appear, however, when the water-soluble polymers are dissolved from the pores associated with them by the influence of water. For more precise production conditions, refer to said specification.

If the surface is structured, properties such as the wetting behavior, the dissolution behavior, the degradation behavior, the adsorption behavior, and the ratio of the surface to the volumes change. The concept is to use in a targeted manner the phase separation starting during electrospinning for the production of such surface structures (8-10). Here, on one hand, the use of a binary system of one polymer and one solvent is possible. In the case of highly volatile solvents, electrospinning leads to a depletion of the solvent and thereby to a phase separation under certain conditions, to the formation of a certain phase morphology, which then finally leads to a corresponding structuring of the fibers. Worth noting is the regularity of the structures which start forming. This is therefore extremely suitable to be used for the production of consistent, retarding carriers. The pores have an ellipsoidal cross-section, wherein they are, by way of example, approximately 300 nm long in the direction of the fiber axis and 50 nm to 150 nm wide perpendicular to this. The second way (see DE 100 40 897 A1 above) provides the use of ternary systems of polymer1/polymer2/solvent. During the formation of the fibers, a segregation of both polymers occurs if they are incompatible. Fibers are formed with a binodal (/dispersoid phase/matrix phase) or co-continual spinodal structure. Such composite fibers are already of interest on their own. If one of the two components is selectively removed, fibers with a specific surface structure result.

iii) WO 2005/115143 A1 describes a modified electrospinning method using arable land and/or several plants and/or plant seeds as counter electrode, wherein nanoscaled and/or nanostructured polymer fibers are produced which are charged with agricultural active agents.

The state of the art is familiar with the nanofiber dispensers mentioned above, which are applied via direct electrospinning in the field. The polymers and active agents are present in a solution from which the nanofibers are subsequently produced in the field. When electrospinning, the nanofibers are produced from a solution. During this process, the solvent evaporates and ends up in the environment. Several polymers are only suitable to be dissolved in organic solvents (e.g. chloroform) and then spun. For these polymers, direct electrospinning in the field is not feasible, as the release of such solvents into the environment is not desired.

Furthermore, the state of the art knows dispensers which function without electrospinning. This includes commercial dispensers such as RAK dispensers (BASF) and Isonet dispensers (Shin-Etsu). These dispensers are manually applied in the respective crop. As a rule, 500 dispensers in total are required per hectare. The manual application form of the dispensers implies a not insubstantial need for manpower.

In practice in agriculture, it is nevertheless more advantageous in some cases to produce these polymer fibers charged with active agents without the help of arable land, plants or plant seeds as counter electrode. It is much more desirable to be able to produce such polymers charged with active agents in advance and only bring them to the site of action if required, for example agricultural land.

### SUMMARY OF THE INVENTION

The present invention overcomes these disadvantages of the state of the art by providing novel, prefabricated dispensers charged with active agents. The present invention describes a device for the application of agricultural active agents, wherein the device is suitable to be brought to the site of action in a manner temporally and spatially separated from the production process, and comprises a dispenser and non-water-soluble nanofibers and/or mesofibers charged with agricultural active agents. Furthermore, a method for the production of this device is disclosed, wherein the nanofibers and/or mesofibers charged with active agents are produced via electrospinning. The device is suitable to be used to bring agricultural active agents to their site of action. This is preferably agricultural land used for fruit growing, viticulture, gardening or a commercial row crop.

### BRIEF DESCRIPTION OF THE DRAWING FIGURES

FIGS. 1 and 2 graphically illustrate graphically illustrate iterations of the recapture data of male moths released in experimental areas treated in accordance with the invention and, for comparison purposes those areas untreated.

FIG. 3 is a schematic representation of a device suitable for carrying out the electrospinning process in accordance with the invention.

### DETAILED DESCRIPTION OF THE INVENTION

It is the aim of the invention to provide a device for the application of agricultural active agents, wherein the device is suitable to be temporally and spatially separated from the production process at the site of action, and a method for the production of this device.

The aim to provide a device for application of agricultural active agents, wherein the device is suitable to be brought to the site of action in a manner temporally and spatially separated from the production process, is achieved according to the present invention by means of a device comprising a dispenser and non-water-soluble nanofibers and/or mesofibers charged with agricultural active agents.

Surprisingly, it was found that non-water-soluble nanofibers and/or mesofibers charged with agricultural active agents are suitable to be deposited on a dispenser, so that they are suitable to be brought to the site of action in a manner temporally and spatially separated from the production process.

The device according to the present invention and the method for its production are explained hereinafter, wherein the invention comprises all the embodiments presented hereinafter individually and in combination with one another.

A “dispenser” is hereby understood to be a manual, semi-automatic or automatic output device for active agents—in this case for agricultural active agents. A carrier material is hereby understood to be a basis or substrate upon which the nanofibers and/or mesofibers charged with active agents are deposited. The dispenser accordingly functions according to the present invention as a carrier material for the nanofibers and/or mesofibers charged with active agents. Agriculturally applicable dispensers are known to persons skilled in the art and are suitable to be used without leaving the scope of protection of the patent claims.

The “site of action” is understood to be the site on which the agricultural active agents are used. By way of example, this is hereby agricultural land, preferably agricultural land used for fruit growing, viticulture, gardening or row crops.

“Water-stable polymer fibers” are understood to be fibers according to the present invention made from such polymers that are essentially non-water-soluble. Essentially non-water soluble polymers are understood according to the present invention to especially be polymers with a solubility in water of less than 0.1 wt.-%. Polymers with a solubility in water which is greater than or equal to 0.1 wt.-% are accordingly understood to be water-soluble polymers according to the present invention.

If the nanofibers and/or mesofibers are water-stable polymer fibers, the polymers are selected from poly(p-xylylene); polyvinyl halides; polyvinylidene halides; polyesters such as polyethylene terephthalates, polybutylene terephthalate, polyvinyl esters; polyethers; polyvinyl ethers; polyolefins such as polyethylene, polypropylene, poly(ethylene/propylene) (EPDM); polycarbonates; polyurethanes; natural polymers, e.g. rubber; polycarbonic acids; polysulfonic acids; sulfated polysaccharides; polylactides; polyglycosides; polyamides; homo and copolymerizates of aromatic vinyl compounds such as poly(alkyl)styrenes, polystyrenes, poly-α-methylstyrenes; polyacrylonitriles; polymethacrylates; polymethacrylonitriles; polyacrylamides; polyimides; polyphenylenes; polysilanes; polysiloxanes; polybenzimidazoles; polybenzothiazoles; polyoxazoles; polysulfides; polyesteramides; polyarylene vinylenes; polyether ketones; polyurethanes; polysulfones; polyvinyl sulfones; polyvinyl sulfonic acids; polyvinyl sulfonic acid esters; inorganic-organic hybrid polymers such as ORMOCER®s by Fraunhofer-Gesellschaft zur Förderung der angewandten Forschung e.V. in Munich; silicones; fully aromatic copolyesters; poly(alkyl)acrylates; poly(alkyl)methacrylates; polyhydroxyethylmethacrylates; polyvinylacetates; poly-isoprene, synthetic rubbers such as chlorobutadiene rubbers, e.g. Neoprene® by DuPont; nitrile butadiene rubbers, e.g. Buna-N®; polybutadiene; polytetrafluoroethylene; modified and unmodified celluloses, homopolymerisates and copolymerisates of α-olefins, vinylsulfonic acids, maleic acids, alginates or collagens, 1,ω-dicarboxylic acids, polyols, in particular 1,ω-diols such as adipic acid.

Furthermore, the polymers are suitable to be made from water-soluble polymers, such as polyvinyl alcohol, polyethylene oxide, polyvinylpyrrolidone or hydroxypropyl cellulose, provided that fibers made from these polymers are stabilized against water by means of a further processing step after electrospinning. This further processing step is preferably a cross-linking. By way of example, this is suitable to be carried out thermally or photochemically or in a radiation-induced manner, wherein the aid of a photoinitiator is particularly advantageous in the case of the photochemical cross-linking. “Radiation-induced” hereby refers to high-energy radiation (higher energy than the visible spectrum), e.g. to UV and X-ray or gamma radiation. Furthermore, the cross-linking is suitable to be carried out via reaction of the water-soluble polymer with a cross-linking agent. These cross-linking agents comprise for example dialdehydes, sodium hypochlorite, isocyanates, dicarboxylic acid halides and chlorinated epoxides. It is known to persons skilled in the art how fibers made from water-soluble polymers are stabilized against water. Persons skilled in the art are able to apply this knowledge without leaving the scope of protection of the patent claims.

Furthermore, the polymers are suitable to be biopolymers. According to the present invention, biopolymers are to be understood to be such polymers which are made by means of polymerization processes from monomer units which occur in nature. Several of these biopolymers are hereinafter named by way of non-exhaustive example, wherein the respective monomer units are indicated in brackets: proteins and peptides (amino acids); polysaccharides such as starch, cellulose, glycogen (glucose), lipids (carboxylic acids), polyglucosamines such as chitin and chitosan (acetylglucosamine, glucosamine); polyhydroxyalkanoates, also referred to as PHB (hydroxyalkanoate); cutin (C16 and C18 subunits); suberine (glycerol and polyphenols); lignin (coumaryl alcohol, coniferyl alcohol, sinapyl alcohol). It is known to persons skilled in the art that several of these biopolymers are water-soluble. Water-soluble biopolymers which are used within the context of the present invention have to be stabilized against water—as described for the synthetic polymers—via a further processing step.

All polymers mentioned above are suitable to be respectively used individually (homopolymers) or in any combination with one another (copolymers). Copolymers are thereby suitable to be made from two or more monomer units which form the polymers mentioned above. Furthermore, the copolymers are suitable to be statistical copolymers, gradient copolymers, alternating copolymers, block copolymers or graft copolymers. All polymers mentioned above are suitable to be used according to the invention individually or in any combination and in any mixing ratio.

Compound additives such as terephthalic acid are suitable to be optionally added to the polymers.

Examples for agricultural active agents are:

Examples for fungicides:

2-aminobutane; 2-anilino-4′-methyl-6-cyclopropyl-pyrimidine; 2′,6′-dibromo-2-methyl-4′-trifluoromethoxy-4′-trifluoro-methyl-1,3-thiazole-5-carboxanilide; 2,6-dichloro-N-(4-trifluoromethylbenzyl)-benzamide; (E)-2-methoxyimino-N-methyl-2-(2-phenoxyphenyl)-acetamide; 8-hydroxyquinoline sulfate; methyl (E)-2-2-[6-(2-cyanophenoxy)-pyrimidine-4-yloxy]-phenyl-3-methoxyacrylate; methyl-(E)-methoximino-[alpha-(o-tolyloxy)-o-tolyl]-acetate; 2-phenylphenol (OPP), aldimorph, ampropylfos, anilazine, azaconazole, benalaxyl, benodanil, benomyl, binapacryl, biphenyl, bitertanol, blasticidin S, bromuconazole, bupirimate, buthiobate, calcium polysulfide, captafol, captan, carbendazim, carboxin, quinomethionate, chloroneb, chloropicrin, chlorothalonil, chlozolinate, cufraneb, cymoxanil, cyproconazole, cyprofuram, dichlorophen, diclobutrazol, dichlofluanid, diclomezine, dicloran, diethofencarb, difenoconazole, dimethirimol, dimethomorph, diniconazole, dinocap, diphenylamine, dipyrithion, ditalimfos, dithianon, dodine, drazoxolon, edifenphos, epoxyconazole, ethirimol, etridiazole, fenarimol, fenbuconazole, fenfuram, fenitropane, fenpiclonil, fenpropidin, fenpropimorph, fentin acetate, fentin hydroxide, ferbam, ferimzone, fluazinam, fludioxonil, fluoromide, fluquinconazole, flusilazole, flusulfamide, flutolanil, flutriafol, folpet, fosetyl-aluminum, fthalide, fuberidazole, furalaxyl, furmecyclox, guazatine, hexachlorobenzene, hexaconazole, hymexazol, imazalil, imibenconazole, iminoctadine, iprobenfos (IBP), iprodione, isoprothiolane, kasugamycin, copper preparations such as: copper hydroxide, copper naphthenate, copper oxychloride, copper sulfate, copper oxide, oxine-copper and Bordeaux mixture, mancopper, mancozeb, maneb, mepanipyrim, mepronil, metalaxyl, metconazole, methasulfocarb, methfuroxam, metiram, metsulfovax, myclobutanil, nickel dimethyldithiocarbamate, nitrothal isopropyl, nuarimol, ofurace, oxadixyl, oxamocarb, oxycarboxin, pefurazoate, penconazole, pencycuron, phosdiphen, pimaricin, piperalin, polyoxin, probenazole, prochloraz, procymidone, propamocarb, propiconazole, propineb, pyrazophos, pyrifenox, pyrimethanil, pyroquilone, quintozene (PCNB), sulfur and sulfur preparations, tebuconazole, tecloftalam, tecnazene, tetraconazole, thiabendazole, thicyofen, thiophanate-methyl, thiram, tolclofos-methyl, tolylfluanide, triadimefon, triadimenol, triazoxide, trichlamide, tricyclazol, tridemorph, triflumizole, triforine, triticonazole, validamycin A, vinclozolin, zineb, ziram, 8-tert.-butyl-2-(N-ethyl-N-n-propyl-amino)-methyl-1,4-dioxa-spiro-[4,5]decane, N—(R)-(1-(4-chlorophenyl)-ethyl)-2,2-dichlor-1-ethyl-3t-methyl-1r-cyclopropanecarboxylic acid amide (diastereomeric mixture or occasional or individual isomers), [2-methyl-1-[[[1(4-methylphenyl)-ethyl]-amino]-carbonyl]-propyl]-carbamine acid 1-methylethylester and 1-methyl-cyclohexyl-1-carboxylic acid-(2,3-dichlor-4-hydroxy)-anilide.

Examples for bactericides are:

Bronopol, dichlorophen, nitrapyrin, nickel dimethyldithiocarbamate, kasugamycin, octhilinone, furan carboxylic acid, oxytetracycline, probenazole, streptomycin, tecloftalam, copper sulfate and other copper preparations.

Examples for acaricides, insecticides and nematicides are:

Abamectin, acephate, acrinathrin, alanycarb, aldicarb, alphamethrin, amitraz, avermectin, AZ 60541, azadirachtin, azinphos A, azinphos M, azocyclotin, Bacillus thuringiensis, 4-bromo-2-(4-chlorphenyl)-1-(ethoxymethyl)-5-(trifluoromethyl)-1H-pyrrole-3-carbonitrile, bendiocarb, benfuracarb, bensultap, betacyfluthrin, bifenthrin, BPMC, brofenprox, bromophos A, bufencarb, buprofezin, butocarboxin, butylpyridaben, cadusafos, carbaryl, carbofuran, carbophenothion, carbosulfan, cartap, chloethocarb, chloretoxyfos, chlorfenvinphos, chlorfluazuron, chlormephos, N-[(6-chloro-3-pyridinyl)-methyl]-N′-cyano-N-methyl-ethanimidamide, chlorpyrifos, chlorpyrifos M, cis-resmethrin, clocythrin, clofentezine, cyanophos, cycloprothrin, cyfluthrin, cyhalothrin, cyhexatin, cypermethrin, cyromazine, deltamethrin, demeton-M, demeton-S, demeton-S-methyl, diafenthiuron, diazinon, dichlofenthion, dichlorvos, dicliphos, dicrotophos, diethion, diflubenzuron, dimethoate, dimethylvinphos, dioxathion, disulfoton, edifenphos, emamectin, esfenvalerate, ethiofencarb, ethion, ethofenprox, ethoprophos, etrimphos, fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazinam, fluazuron, flucycloxuron, flucythrinate, flufenoxuron, flufenprox, fluvalinate, fonophos, formothion, fosthiazate, fubfenprox, furathiocarb, HCH, heptenophos, hexaflumuron, hexythiazox, imidacloprid, iprobenfos, isazophos, isofenphos, isoprocarb, isoxathion, ivermectin, lambda-cyhalothrin, lufenuron, malathion, mecarbam, mevinphos, mesulfenphos, metaldehyde, methacrifos, methamidophos, methidathion, methiocarb, methomyl, metolcarb, milbemectin, monocrotophos, moxidectin, naled, NC 184, nitenpyram, omethoate, oxamyl, oxydemethon M, oxydeprofos, parathion A, parathion M, permethrin, phenthoate, phorate, phosalone, phosmet, phosphamidon, phoxim, pirimicarb, pirimiphos M, pirimiphos A, profenophos, promecarb, propaphos, propoxur, prothiophos, prothoate, pymetrozin, pyrachlophos, pyridaphenthion, pyresmethrin, pyrethrum, pyridaben, pyrimidifen, pyriproxifen, quinalphos, salithion, sebufos, silafluofen, sulfotep, sulprofos, tebufenozide, tebufenpyrad, tebupirimiphos, teflubenzuron, tefluthrin, temephos, terbam, terbufos, tetrachlorvinphos, thiafenox, thiodicarb, thiofanox, thiomethon, thionazin, thuringiensin, tralomethrin, triarathen, triazophos, triazuron, trichlorfon, triflumuron, trimethacarb, vamidothion, XMC, xylylcarb, zetamethrin, substituted propargylamines, as described in DE 102 17 697, dihalogenpropene compounds, as described in DE 101 55 385, pyrazolyl benzyl ether, as described in DE 199 61 330, pyrazole derivatives as described in DE 696 27 281.

Examples for herbicides:

Anilides, such as diflufenican and propanil; aryl carboxylic acids, such as dichloropicolinic acid, dicamba and picloram; aryloxyalkanoic acids, such as 2,4-D, 2,4-DB, 2,4-DP, fluoroxypyr, MCPA, MCPP and triclopyr; aryloxy-phenoxy-alkanoic acid esters, such as diclofop-methyl, fenoxaprop-ethyl, fluazifop-butyl, haloxyfop-methyl and quizalofop-ethyl; azinones, such as chloridazon and norflurazon; carbamates, such as chlorpropham, desmedipham, phenmedipham and propham; chloroacetanilides, such as alachlor, acetochlor, butachlor, metazachlor, metolachlor, pretilachlor and propachlor; dinitroanilines, such as oryzalin, pendimethalin and trifluralin; diphenyl ethers, such as acifluorfen, bifenox, fluoroglycofen, fomesafen, halosafen, lactofen and oxyfluorfen; ureas, such as chlortoluron, diuron, fluometuron, isoproturon, linuron and methabenzthiazuron; hydroxylamines, such as alloxydim, clethodim, cycloxydim, sethoxydim and tralkoxydim; imidazolinones, such as imazethapyr, imazamethabenz, imazapyr and imazaquin; nitriles, such as bromoxynil, dichlobenile and ioxynil; oxyacetamides, such as mefenacet; sulfonylureas, such as amidosulfuron, bensulfuron methyl, chlorimuron ethyl, chlorsulfuron, cinosulfuron, metsulfuron-methyl, nicosulfuron, primisulfuron, pyrazosulfuron-ethyl, thifensulfuron-methyl, triasulfuron and tribenuron-methyl; thiolcarbamates, such as butylates, cycloates, diallates, EPTC, esprocarb, molinates prosulfocarb, thiobencarb and triallates; triazines, such as atrazine, cyanazine, simazine, simetryne, terbutryne and terbutylazine; triazinones, such as hexazinone, metamitron and metribuzin; others, such as aminotriazole, benfuresates, bentazones, cinmethylin, clomazones, clopyralid, difenzoquat, dithiopyr, ethofumesates, fluorochloridones, glufosinates, glyphosates, isoxaben, pyridates, quinchlorac, quinmerac, sulfosates and tridiphanes.

Chlorocholine chloride and ethephon are to be named as examples for plant growth regulators.

An “agricultural active agent” is hereby understood to be compounds which comprise at least one of the substances mentioned above.

Conventional inorganic or organic fertilizers for feeding plants with macronutrients and/or micronutrients are to be mentioned as examples for plant nutrients. All conventional applicable substances in such preparations are considered as additives which are known to be suitable to be contained within the agricultural active agents according to the present invention. Fillers, lubricants and greasing means known from plastics engineering, plasticizers and stabilizing agents preferably come into consideration.

Examples for fillers are: Sodium chloride, carbonates such as calcium carbonate or sodium hydrogen carbonate, aluminum oxides, silica, alumina, precipitated or colloidal silicon dioxide, and phosphates.

Examples for lubricants and greasing means are: Magnesium stearate, stearic acid, talc and bentonites.

All substances which are normally used as plasticizers for polyester amides are considered as plasticizers. Esters from phosphoric acid, esters from phthalic acid, such as dimethyl phthalate and dioctyl phthalate, and esters from adipic acid, such as diisobutyl adipate, and esters from azelaic acid, malic acid, citric acid, maleic acid, ricinoleic acid, myristic acid, palmitic acid, oleic acid, sebacic acid, stearic acid, trimellitic acid, and complex linear polyesters, polymeric plasticizers and epoxidized soybean oils are named as examples.

Antioxidants and substances that protect polymers from undesired degradation during processing are considered as stabilizing agents. In the active agents according to the present invention, all conventionally applicable dyes for agricultural active agents are suitable to be comprised as dyes. The concentrations of the individual components are suitable to be varied within a large range in the agricultural active agents.

Furthermore, UV protection agents are optionally suitable to be integrated into the fibers, for example in order to protect UV-unstable pheromones. Suitable protection agents are, by way of non-exhaustive example, aromatic compounds such as 2,6-di-tert-butyl-4-methylphenol or aromatic amines.

The nano-polymer fibers and/or meso-polymer fibers according to the present invention preferably comprise biodegradable polymers.

Biodegradable is hereby understood to mean that a compound (here: the homopolymer or copolymer from which the nanofibers and/or mesofibers are comprised) is decomposed into smaller degradation products via enzymes and/or microorganisms. The degradation is suitable to occur in a sewage treatment or composting plant, or on the agricultural land on which the devices according to the present invention are applied. In the latter case, the biodegradable polymers are chosen in such a way that they are only fully degraded after the end of the vegetation period. The degradation preferably begins only shortly before the end of the vegetation period or at the beginning of the dormant period for the plants, which should be protected from infestations of pests via the devices according to the present invention.

In a preferred practical embodiment, the nanofibers and/or mesofibers are electrospun fibers.

In another practical embodiment, the dispenser is an anti-hail net.

In another embodiment, the agricultural active agent is selected from the group of pheromones, kairomones and signaling substances.

In another embodiment, the device according to the present invention is nanofibers and/or mesofibers charged with pheromones which are applied to an anti-hail net.

The aim of providing a method for the production of the device according to the present invention is achieved by means of a method comprising the following steps:
a) mixing the agricultural active agent with polymers comprising the at least one of nanofibers and mesofibers in a solvent or as a melt,
b) applying the dispenser to a counter electrode of an electrospinning device, and
c) depositing the polymer agent mixture obtained in step a) on the dispenser using an electrospinning method.

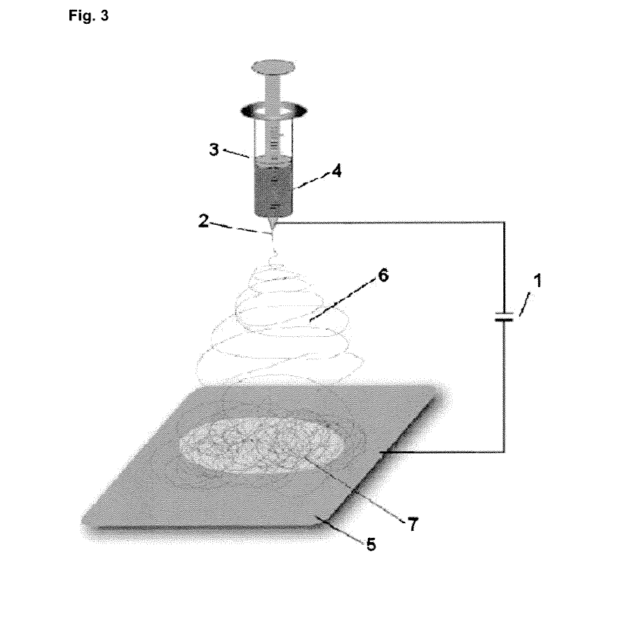

The device for the application of agricultural active agents according to the present invention comprising a dispenser and non-water-soluble nanofibers and/or mesofibers charged with agricultural active agents is produced by applying at least one carrier material to the counter electrode 7 of an electrospinning device (as shown in FIG. 3) and depositing at least the nanofibers and/or mesofibers charged with the agricultural active agent onto it with the aid of the electrospinning method.

The material to be spun does not necessarily have to touch the counter electrode. Alternatively, the material to be spun is suitable to be conducted without contact via the surface of the electrodes in a continual process.

In an embodiment, the polymer or polymers/polymer(s) from which the nanofibers and/or mesofibers are to be produced is/are dissolved in at least one solvent according to step a) prior to electrospinning. “Dissolvable” is hereby understood to mean that the polymer or polymers comprises/comprise a solubility of, respectively, at least 1 wt.-% in the corresponding solvent. The agricultural active agent is either also dissolved in a solvent (preferably the same one) and both solutions are then mixed with one another, or the active agent is dissolved in the solution of the polymer or polymers.

Persons skilled in the art know which polymers are dissolvable in the sense of the definition above in which solvents or solvent mixtures. Persons skilled in the art are able to apply this knowledge without leaving the scope of protection of the patent claims.

Suitable solvents are, by way of non-exhaustive example:
Water,
aliphatic alcohols, for example methanol, ethanol, n-propanol, 2-propanol, n-butanol, iso-butanol, tert.-butanol, cyclohexanol,
carboxylic acids, for example formic acid, acetic acid, trifluoroacetic acid which are liquid at room temperature,
amines, for example diethylamine, diisopropylamine, phenylethylamine,
polar aprotic solvents, for example acetone, acetyl acetone, acetonitrile, acetic acid ethylester, diethylene glycol, formamide, dimethylformamide (DMF), dimethyl sulfoxide (DMSO), dimethyl acetamide, N-methylpyrrolidone (NMP), pyridine, benzyl alcohol,
halogenated hydrocarbons, for example dichloromethane, chloroform,
non-polar, aliphatic solvents, for example alkanes selected from hexane, heptane, octane and cycloalkanes selected from cyclopentane, cyclohexane, cycloheptane,
non-polar aromatic solvents, for example benzene, toluene,
ionic liquids.

In another embodiment, a polymer melt is produced in step a) and the agricultural active agent is dissolved in this melt. This embodiment is suitable for such polymers and agricultural active agents which are sufficiently stable from a thermal perspective. Persons skilled in the art know which polymers and agricultural active agents comprise the necessary thermal stability. Persons skilled in the art are able to apply this knowledge without leaving the scope of protection of the patent claims. For example, pheromones in a vacuum and in the absence of oxygen are therefore stable up to approx. 180° C.

If electrospinning takes place from polymer solutions, the polymer content of these solutions is therefore 1 wt.-% to 50 wt.-%, particularly advantageously 1 wt.-% to 25 wt.-%.

The ratio of the agricultural active agent is up to 50 wt.-% of the completed and non-water-stable nano-polymer fibers and/or meso-polymer fibers charged with active agents.

The polymer solution to be used according to the present invention is suitable to be electrospun in all of the manners known to persons skilled in the art, for example by extruding the solution under low pressure by means of a channel connected with a terminal of a voltage source to a counter electrode arranged at a distance from the channel entrance. The dispenser is located on this counter electrode.

The distance between the cannula and the counter electrode functioning as a collector and the voltage between the electrodes are chosen in such a way that an electrical field of preferably 0.5 to 2 kV/cm is formed between the electrodes. A material flow directed toward the counter electrode is formed, which solidifies on the way to the counter electrode.

Good results are obtained in particular when the diameter of the cannula is 50 μm to 500 μm.

In an embodiment of the method according to the present invention, an electrospinning device is proposed that comprises a voltage source which is suitable to deliver voltages between 1 and 100 kV, and a nozzle/tip/syringe which is electrically connected to it. The device preferably comprises a means for storing and/or mixing the polymers, solvents and agricultural active agents used.

In another embodiment, the device for the improved control of the application process according to the present invention comprises at least one counter electrode which is mechanically and/or electrically connected to the device. This counter electrode comprises a different electrical potential to the nozzle or tip used as a first electrode with an opening for the polymer(s) to pass through.

It is provided in another advantageous practical embodiment that a second outer nozzle/tip/syringe is provided in a coaxial manner to the first inner nozzle/tip/syringe. Each of the two nozzles/tips/syringes are suitable to be connected with its own or a joint storage container for the delivery of polymers in solution. Furthermore, storage containers are suitable to be provided for the active agents.

The device furthermore preferably comprises a pressurizing means which puts one or both of the containers provided under pressure in order to deliver the polymers and/or active agents to the nozzle/tip/syringe. The mixture or mixing of the polymers with the active agents is hereby suitable to occur in the storage container or along the flow path to the nozzle. This is for example achieved by an arrangement of the joint flow path of the polymer and active agent to the device's tip in such a way that turbulences in the flow and therefore a mixture of the polymer and active agent is suitable to be observed.

The device's two nozzles or tips hereby comprise the same electric potential. For the production of multi-layer fibers, the device is suitable to comprise further nozzles or tips which are respectively arranged around the respective inner one.

For the method according to the present invention to succeed, simply a voltage source and a nozzle/tip/syringe electrically connected to it for the passage of the polymer are essential with regard to the electrospinning device. Furthermore, at least one further storage container for the polymer and the active agent with a nozzle connected to it and a means for mixing it if necessary is preferably provided.

For the improved control of the passage of the polymer-active agent mixture, a pressure device is provided which exerts pressure on the mixture in the direction of the outlet of the nozzle. For the optimum control of the mixture's flow rate, this pressure device is suitable to be connected with a control device which is itself connected with a signal generator such as a flow rate or flow velocity sensor.

The continual application of constant nanoscaled polymer fibers (with or without active agent) is therefore suitable to be regulated depending on the actual values of the flow rate or the flow velocity in the nozzle or nozzle tip or depending on the temperature(s) of the melt/the mixture/the solution.

In another practical embodiment, the device is suitable to comprise a means for measuring and controlling and/or regulating the carrier amount (mass, volumes or surface of the nanoscale fibers or tubes) delivered, e.g. in the form of a weighing instrument or in the form of visual means of recognition, for example in combination with a flow meter (which is also suitable to be designed in the form of an inductive flow meter for the reduction of flow resistance). Alternatively, a flow velocity meter in combination with the known flow meter diameter is suitable to provide information about the carrier amount in the form of nanoscaled fibers or tubes which is delivered per unit of time. These means would be particularly suitable to be used for calibrating the device, so that the correct respective parameters for the desired application per time or surface may be adjusted on the device before starting to apply the nanofibers and/or mesofibers and active agents.

Another advantageous practical embodiment provides that a device for the production of electrical potential produces a device for the production of a high-voltage alternating field between the first electrode (the device's nozzle) and the counter electrode (or electrodes, i.e. the dispenser(s)). In doing so, the degree of “entanglement” with the target area via the fibers is suitable to be increased. This alternating field is also suitable to be mechanically generated and preferably generated via one or several flexible, preferably rotary nozzles in the firm of hook-shaped or rod-shaped electrodes.

In a particularly preferred embodiment, the electrospinning device comprises two or more nozzles arranged in a coaxial manner to one another for the discharge of the polymer(s). The outlets of all of these nozzles are preferably on one level and comprise the same electrical potential, so that co-electrospinning is suitable to be implemented via these nozzles, meaning that a core fiber and a surrounding fiber are suitable to be produced.

In another embodiment, the devices comprise other means for coating the nanoscaled fiber leaving the first nozzle (i.e. the first electrode). These means are preferably the known means for implementing thin-film deposition processes, e.g. sputter technology, chemical deposition from gas phases (CVD, MOCVD), evaporative technologies and pyrolysis.

The nanofibers and/or mesofibers or hollow fibers according to the present invention comprise a surface of 100 to 700 g/m² and a diameter of 10 nm to 5 μm, preferably from 10 nm to 2 μm and lengths of 1 μm to up to several meters. Diameters of 10 nm to 1 μm are preferred.

Persons skilled in the art know how the fiber diameter may be adjusted. As such, by way of example, the larger the fiber diameter, the more viscous it is, i.e. the more concentrated the polymer solution to be spun. The higher the flow rate of the spinning solution per unit of time, the larger the diameter of the electrospun fibers obtained. Furthermore, the fiber diameter depends on the surface tension and the conductivity of the spinning solution. This is known to persons skilled in the art, and persons skilled in the art may use this knowledge without leaving the scope of protection of the patent claims.

In the (optional) case of hollow fibers, these hollow fibers are suitable to be produced by producing a massive fiber from a degradable polymer in a first step. This fiber is then coated with a second non-degradable material. Several layers of the same or different non-degradable materials are also suitable to optionally be deposited. The first massive fiber is then removed, e.g. thermally, via irradiation or with a solvent. This leaves a hollow fiber whose inner wall comprises the second non-degradable material and whose outer wall comprises the most recently applied non-degradable material. Furthermore, it is obvious in the context of the present invention that hollow fibers will only be used when the agricultural active agent to be used is neither destroyed nor removed during the production process of these hollow fibers.

The device according to the present invention is suitable to be used to bring agricultural active agents to the site of action in a manner temporally and spatially separated from the production of this device. This is hereby preferably agricultural land used for fruit growing, viticulture, gardening or a commercial row crop.

The application is hereby suitable to be manually or mechanically administered. If required, the devices according to the present invention are suitable to be installed on or between the plants. Methods for installing carriers of agricultural active agents are known to persons skilled in the art. As such, the application and the attaching of the devices according to the present invention are suitable to take place, by way of example, with the help of a modified leaf tying machine, as is usual in viticulture. Instead of the basting cotton for the leaves, the nanofibers and/or mesofibers with the carrier material according to the present invention are distributed on and attached to the vines or fruit trees. Alternatively, the dispensers charged with nanofibers and/or mesofibers and agricultural active agents according to the present invention would be suitable to be virtually ‘indefinitely’ rolled up and then unrolled along a whole row of fruit trees or vines.

The devices according to the present invention are particularly preferably used for the regulation of arthropods, for example in fruit growing, viticulture, gardening or a commercial row crop. Cotton, corn and rice, and preferably almonds, nuts and pistachios are, by way of example, part of commercial row crops. Pheromones, kairomones or signaling substances in a certain amount depending on the agricultural pests considered are applied on the field. This results in the harmful male organisms from not being able to orient themselves around the female organisms anymore, meaning that copulation does not occur. Fertilized eggs are not laid, thereby leading to a reduction in the agricultural pest population. This method of disruption (“mating disruption”) works so effectively that applications of insecticides which generally work against larvae are suitable to be replaced. Pheromones and kairomones and signaling substances are natural substances of which no harmful side-effects are known for humans or the environment, and only work on the target organism. Resistance phenomena which frequently appear in chemical-synthetic plant protection agents are also not expected. The method of disruption with these active agents is therefore a highly environmentally friendly method for plant protection.

### PRACTICAL EMBODIMENTS

### Practical Embodiment

### Cage Tests for Ascertaining the Suitability of Polymer Nonwovens as Pheromone Dispensers in Viticulture

The cage test is a standard method for testing substances which are intended to be applied in viticulture on a large scale for the purpose of disrupting copulation. This method then determines for the means to be tested whether the formulation administered shows a biological effect.

### Experimental Conditions

Testing took place in the vineyards with varieties customary to that particular place. The following served as test organisms depending on the indication to be tested:
Eupoecilia ambiguella (vine moth)
Lobesia botrana (European grapevine moth)

The testing of the biological effectiveness exclusively took place outside. For the experimental areas, vineyards are provided in which, according to experience, infestations are likely to occur.

### Test Principle

A defined number of male moths were attracted by a natural pheromone source (non-copulated females). The females are placed in small filter cages over a glue base in such a way that males that have successfully found the females become caught on the glue base. If a pheromone preparation is used around the cage, the males should not be able to purposefully approach the females any more. The lower the number of caught males within an area of pheromonal confusion in a cage, the more effective the copulation is disrupted (compared with a cage in an area of non-confusion used as a control).

### Experimental Facility

### Type of Cage

The aviaries are made from metal lattices.
The mesh opening allows for an unobstructed flow of air whilst simultaneously preventing the moths from flying through the lattice.
The size of the cage is approx. 5 m³.
The cage is installed over a row of vines.
The cage contains two traps in which two living, non-copulated females are held as bait. The traps are fitted with an adhesive base on which all of the males which have successfully found the alluring females get caught.

### Release and Assessment

One cage is assembled per variant (nonwoven polymer, control, means for comparison if necessary).
Nonwoven polymers over a surface of 0.2 ha (=2,000 m²) are deployed around the cage of the testing variant. This surface is normally equipped with 100 conventional dispensers (RAK or Isonet).
Two traps with two living, non-copulated females are hanged in each cage, respectively, and 40 male vine moths bred in the laboratory are released per cage.
Three to seven days after release (depending on the weather conditions), the number of animals caught on the adhesive bases is noted.
The females in the bait traps are then exchanged, and 40 male vine moths are released again.
Three to seven days after the second release, the number of animals caught on the adhesive bases is noted again.
As a rule, a third release and subsequent examination occurs.
The recatch quota is calculated against the control variant (see below).

The animals that were used in the test and the control test were of the same origin and the same age. The site for the control cage was chosen in such a way that there was no influence from artificial pheromone sources.

### Meteorological Data

Continual weather records from the nearest weather station during the experimental phase were implemented and are available for the interpretation of the test results.

### Determination of the Recapture Quota for the Cage Tests

The number of males adhered to the glue base/adhesive base of the female trap serves as the recapture.

The recapture quota Q is the percent value independent of the number of male moths actually used. This allows for various tests and test substances to be compared to each other. When Q=100%, a test substance does not differ from the control substance. The lower Q is, the more effectively the copulation is disrupted.

Q=R/Rk*100[%]

Q=recapture quota, R=recapture in testing variants, Rk=recapture in the control test

### Results of the Outdoor Cage Test

### 1^{st} Experiment, 1^{st} Repetition

Ecoflex® nanofibers with the vine moth pheromone as a dispenser; quantity applied over an experimental area of 2,000 m²: 200 g of nanofibers with a pheromone content of 33% spun over an anti-hail net prior to application; dispersal of 100 sections (1.5 m-long) of anti-hail net spun with nanofibers over the 2,000 m² experimental area around the cage.

### 1^{st} Experiment, 2^{nd} Reiteration

The second reiteration was carried out in exactly the same way as the first.

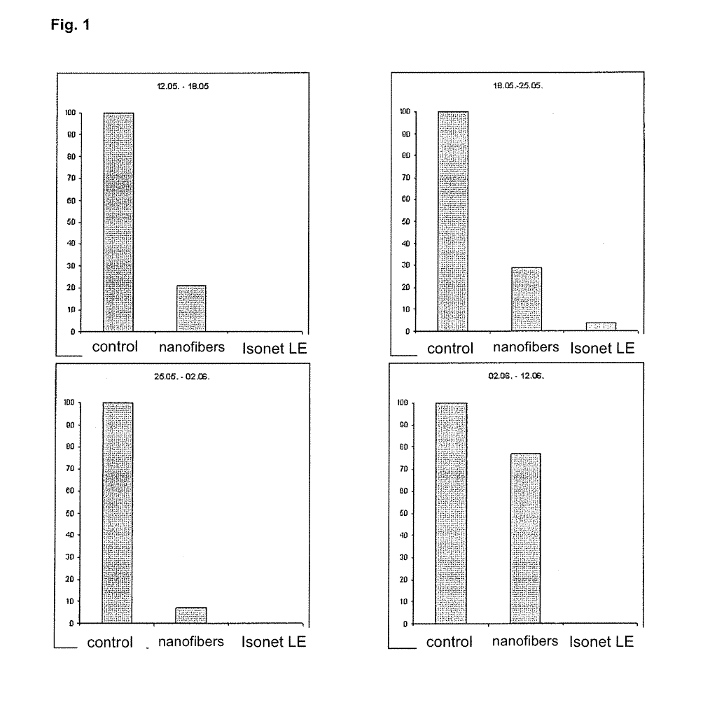

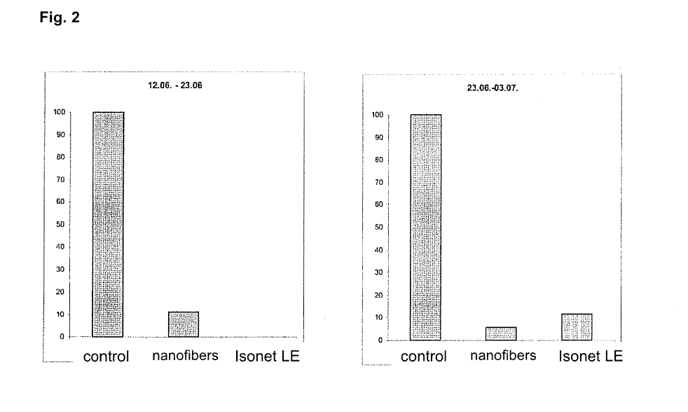

The results of both reiterations are graphically presented in FIGS. 1 and 2.

A good confusion effect is suitable to be observed in the first three weeks in the first repetition of the test (see also FIG. 1). It is only in the fourth week that sufficient effect is no longer suitable to be recognized. These results are suitable to be reproduced in the second repetition.

Ecoflex® is a biodegradable, static aliphatic-aromatic copolyester based on the monomers 1,4 butanediol and adipic acid, and terephthalic acid as a compound additive.

Isonet LE® is a commercially available pheromone comprising 52% (7E,9Z)-dodecadienyl acetate and 48% (Z)-9-dodecenyl acetate.

### LIST OF REFERENCE NUMERALS

1 Voltage source
2 Capillary nozzle
3 Syringe
4 Spinning solution
5 Counter electrode
6 Fiber formation
7 Fiber nonwoven

### FIGURE LEGENDS

### FIG. 1

### 1^{st} Experiment, 1^{st} Repetition:

Ecoflex® nanofibers with the vine moth pheromone as a dispenser; quantity applied over an experimental area of 2,000 m²: 200 g of nanofibers with a pheromone content of 33% spun over an anti-hail net prior to deployment; dispersal of 100 sections (1.5 m-long) of anti-hail net spun with nanofibers over the 2,000 m² experimental area around the cage.

The columns in the graphs respectively represent the recapture quota of the male moths released in the cages. The recapture in the untreated controls are defined as 100%, and the recaptures in nanofiber variant and the variant with the standard dispenser are compared thereto.

### FIG. 2

### 1^{st} Experiment, 2^{nd} Repetition:

The experimental conditions were selected as described under FIG. 1, and the graphical presentation was carried out analogously to the 1^{st} repetition.

### FIG. 3

FIG. 3 shows a schematic representation of a device suitable for carrying out the electrospinning process according to the present invention.

The device comprises a syringe 3, at the tip of which a capillary nozzle 2 is located. This capillary nozzle 2 is connected to a pole of a voltage source 1. The syringe 3 takes up the solution 4 to be spun. Arranged at a distance of approximately 20 cm opposite the outlet of the capillary nozzle 2 is a counter electrode 5 which is connected to the other pole of the voltage source 1 and which acts as a collector for the fibers that are formed.

During the operation of the device, a tension between 15 kV and 150 kV is set on the electrodes 2 and 5, and the polymer solution 4 is delivered through the capillary nozzle 2 or the syringe 3 under low pressure. Due to the electrostatic charge of the polymers in the solution resulting from the strong electric field of 0.5 to 2 kV/cm, a material flow directed toward the counter electrode 5 occurs, which solidifies on the way to the counter electrode 5, forming fibers 6, as a result of which fibers 7 having diameters in the micrometer and nanometer scale are deposited on the counter electrode 5.

1. A device for the application of agricultural active agents, the device comprising a dispenser and at least one of non-water-soluble nanofibers and mesofibers charged with agricultural active agents, said device being suitable to be brought to a site where the agricultural active agents are applied in a manner temporally and spatially separated from the production process.

2. The device according to claim 1, wherein the at least one of non-water-soluble nanofibers and mesofibers are electrospun.

3. The device according to claim 1, wherein the agricultural active agent is selected from the group consisting of pheromones, kairomones and signaling substances.

4. The device according to claim 1, wherein the dispenser is an anti-hail net.

5. A method for the production of a device according to claim 1, the method comprising:
a) mixing the agricultural active agent with polymers comprising the at least one of nanofibers and mesofibers in a solvent or as a melt,
b) applying the dispenser to a counter electrode of an electrospinning device, and
c) depositing the mixture obtained in step a) on the dispenser using an electrospinning method.

6. The device according to claim 1, wherein the site is agricultural land used for fruit growing, viticulture, gardening or commercial row crops.

7. The device according to claim 6, wherein agricultural active agents are applied for the regulation of arthropods.

8. The device according to claim 1, wherein the at least one of non-water-soluble nanofibers and mesofibers comprise a polymer selected from the group consisting of poly(p-xylylene), polyvinyl halides, polyvinylidene halides, polyesters, polyethers, polyvinyl ethers, polyolefins, polycarbonates, polyurethanes, natural polymers, polycarbonic acids, polysulfonic acids, sulfated polysaccharides, polylactides, polyglycosides, polyamides, homo and copolymerizates of aromatic vinyl compounds, polyacrylonitriles, polymethacrylates, polymethacrylonitriles, polyacrylamides, polyimides, polyphenylenes, polysilanes, polysiloxanes, polybenzimidazoles, polybenzothiazoles, polyoxazoles, polysulfides, polyesteramides, polyarylene vinylenes, polyether ketones, polyurethanes, polysulfones, polyvinyl sulfones, polyvinyl sulfonic acids, polyvinyl sulfonic acid esters, inorganic-organic hybrid polymers, silicones, fully aromatic copolyesters, poly(alkyl)acrylates, poly(alkyl)methacrylates, polyhydroxyethylmethacrylates, polyvinylacetates, polyisoprene, synthetic rubbers, nitrile butadiene rubbers, polybutadiene, polytetrafluoroethylene, modified and unmodified celluloses, homopolymerisates and copolymerisates of α-olefins, vinylsulfonic acids, maleic acids, alginates or collagens, 1,ω-dicarboxylic acids, and polyols.

9. The method according to claim 5, wherein the agricultural active agent is mixed with the polymers in the solvent, and the solvent is selected from the group consisting of water, aliphatic alcohols, carboxylic acids, amines, polar aprotic solvents, halogenated hydrocarbons, non-polar aliphatic solvents, non-polar aromatic solvents, and ionic liquids.
